(19) United States
(12) Patent Application Publication
(10) Pub. No.: US 2017/0315431 A1
(43) Pub. Date: Nov. 2, 2017

(54) LIGHTING DEVICE INCLUDING PUMP RADIATION SOURCE

(71) Applicant: OSRAM GmbH, Munich (DE)

(72) Inventors: Martin Schnarrenberger, Berlin (DE); Dirk Amsbeck, Berlin (DE); Norbert Magg, Berlin (DE)

(73) Assignee: OSRAM GmbH, Munich (DE)

(21) Appl. No.: 15/520,858

(22) PCT Filed: Sep. 29, 2015
(86) PCT No.: PCT/EP2015/072335

§ 371 Date: Apr. 21, 2017

(30) Foreign Application Priority Data
Oct. 21, 2014 (DE) 10 2014 221 382.7

(51) Int. Cl. G03B 21/20; H04N 9/31; G03B 33/08; G02B 27/14; G02B 27/10; G02B 26/00; F21V 9/16; F21Y 2115/30

(52) U.S. Cl. CPC G03B 21/204; H04N 9/3158; H04N 9/3117; G03B 33/08; G03B 21/2066; G02B 27/141; G02B 27/1006; G02B 26/008; F21V 9/16; F21Y 2115/30

(57) ABSTRACT

A lighting device is provided with a pump radiation source for emitting pump radiation, a first phosphor element for converting the radiation into a first conversion light, a second phosphor element for generating a second conversion light, and a coupling-out mirror arranged downstream of the first element in a beam path with at least part of the first light. The first light is a broadband conversion light having components in first and second spectral ranges, and the coupling-out mirror is transmissive only in one of the two ranges such that, lights having first and second spectral components in the first and second spectral ranges are separated. The second element is arranged in a beam path with the light having the second component and, in response to this excitation, emits the second light, which can be used jointly with the light having the first component in order to increase the efficiency.

### RELATED APPLICATIONS

The present application is a national stage entry according to 35 U.S.C. §371 of PCT application No.: PCT/EP2015/072335 filed on Sep. 29, 2015, which claims priority from German application No.: 10 2014 221 382.7 filed on Oct. 21, 2014, and is incorporated herein by reference in its entirety.

### TECHNICAL FIELD

The present disclosure relates to a lighting device including a pump radiation source for emitting pump radiation, and a phosphor element for converting the pump radiation into conversion light.

### BACKGROUND

A lighting device of the present type can find application for example as a light source in a projection apparatus. The combination of a pump radiation source with a phosphor element arranged at a distance therefrom makes it possible to achieve a high luminance. In response to the excitation with the pump radiation, the phosphor element emits conversion light of a specific color, which can then supply a color channel (for example red, green or blue). By virtue of the fact that phosphor elements which differ in their color of the conversion light are excited sequentially, the corresponding channels are then available sequentially and a mixed image of the different colors arises over the course of time for an observer. This is intended to illustrate one field of application, but not to restrict the generality of the subject matter.

The present disclosure addresses the technical problem of specifying a particularly advantageous lighting device.

### SUMMARY

According to the present disclosure, this problem is solved by a lighting device including a pump radiation source for emitting pump radiation, a first phosphor element for converting the pump radiation into a first conversion light, a second phosphor element for generating a second conversion light, and a coupling-out mirror, which is arranged downstream of the first phosphor element in a beam path with at least part of the first conversion light, wherein the first conversion light is a broadband conversion light having components in a first spectral range and a (non-overlapping) second spectral range, which is different from said first spectral range, wherein the coupling-out mirror arranged in the beam path with at least part of the first conversion light is transmissive only in one of the two spectral ranges but is reflective in the other spectral range, such that, downstream of the coupling-out mirror, light having a first spectral component in the first spectral range and light having a second spectral component in the second spectral range are present in a separated fashion, wherein at least part of the light having the first spectral component is available at an output of the lighting device, and wherein furthermore the second phosphor element is arranged in a beam path with at least part of the light—separated by the coupling-out mirror—having the second spectral component (downstream of the coupling-out mirror in relation to said light) and, in response to this excitation, emits the second conversion light, which can be used jointly with the light having the first spectral component in order to increase the efficiency.

Preferred embodiments are found in the dependent claims and the present description, wherein a distinction between device and use aspects is not always specifically drawn in the explanation; the disclosure should at any rate be interpreted implicitly with regard to all claim categories.

In order that light of a specific color is made available at the output, therefore, firstly no phosphor (excited with the pump radiation) is chosen whose conversion light already has the desired color originally, that is to say without spectral modification. However, the corresponding, “first” conversion light has a spectral component (the “first”) in the spectral range (the “first”) which corresponds to the ultimately desired color. A phosphor that emits correspondingly broadband conversion light is also referred to as a broadband phosphor. By comparison with a phosphor which already originally emits light of the desired color, it may for example be more efficient, for instance in comparison with some red phosphors that may exhibit quenching at higher powers; secondly, a broadband phosphor may also be available cost-effectively.

An approach conceivable by the inventors as an alternative to the present concept would have consisted in filtering out the other, “second” spectral range of the first conversion light, that is to say in using solely the first spectral range of the desired color. According to the combination of features in accordance with the main claim, now not only is the light having the first spectral component—which light is desired with regard to the color—made available at the output, but the light having the second spectral component is also used further, which can improve the efficiency. By virtue of the fact that the second phosphor element is excited with the light having the second spectral component, it emits the second conversion light in response to the excitation and additional light having a suitable spectral distribution is thus available.

As explained further in detail below, the second conversion light has approximately the same color as the light having the first spectral component at the output. Therefore, more light of the desired color is then available. For instance, in the case of an application mentioned in the introduction with sequentially output channels of different colors, the channel output in a time interval is thus “amplified”; without the repeated conversion with the second phosphor, by contrast, the color of the light having the second spectral component would be at a color deviating from the currently output channel, that is to say would not be usable.

For separating the light having the first and second spectral components, the coupling-out mirror is provided, which is reflective or transmissive in a wavelength-dependent manner. Therefore, the light having the first spectral component can be reflected and the light having the second spectral component can be transmitted, or vice versa. At any rate a reflected and a transmitted beam path are present downstream of the coupling-out mirror; the light having the first spectral component is found in one beam path, and the light having the second spectral component in the other beam path. In this respect, “coupling out” means that the light having the first spectral component is then available for illumination purposes; by contrast, the light having the second spectral component is conditioned again beforehand in the manner described in the present case. The output is then a section proceeding from which the desired light is available, and is not necessarily formed by an aperture (pinhole diaphragm) or a final optical element relative to the beam propagation; e.g. beam shaping is also possible downstream as well.

The fact that the coupling-out mirror/beam splitter is “transmissive” in one of the two spectral ranges means, for example, that at least 60%, advantageously at least 70%, more advantageously at least 80%, of that part of the first conversion light which lies in said spectral range is transmitted; “reflective” means, for example, at least 60%, advantageously at least 70%, more advantageously at least 80%, of that part of the first conversion light which lies in the corresponding spectral range is reflected. 100% is preferred in each case, but it may be 95% or 90%, for example, owing to technical dictates. Owing to a possible dependence on angles of incidence, the indications relate specifically to the situation in the lighting device. Corresponding percentages may generally be preferred in the context of this disclosure, insofar as reference is made to the fact that a wavelength-dependent mirror transmits or reflects in a specific spectral range or specific light.

As beam splitter (wavelength-dependent mirror) an interference mirror is preferred, also referred to as “dichroic mirror”, for instance a multilayer system including at least two dielectric layer materials which differ in their refractive indices and are arranged alternately in succession. A first layer material may be silicon dioxide, for example, and a second layer material may be titanium dioxide, for example. The beam splitter may be designed for example as a high-pass filter or low-pass filter, that is to say with exactly one limiting wavelength, or else as a bandpass filter or band-stop filter having two limiting wavelengths; it transmits in its passband and reflects in the stop band. Generally, insofar as reference is made to a wavelength-dependent mirror in the context of this disclosure, it may be configured in the manner just described (that is to say also different mirrors than the coupling-out mirror).

The “broadband conversion light” separated by the coupling-out mirror may have for example a spectral intensity distribution which, over a wavelength range of at least 30 nm, advantageously at least 60 nm, more advantageously at least 100 nm, exhibits continuously (at all wavelengths within the range) an intensity which in each case makes up at least 10%, advantageously at least 20%, more advantageously at least 30%, of a maximum value of the intensity in the visible spectral range (between 380 nm and 780 nm).

In general, the “pump radiation” may also be UV radiation, for example; blue pump light is preferred, for example having a dominant wavelength of 405 nm or 450 nm. Laser radiation is preferred as pump radiation, that is to say that the pump radiation source is advantageously a laser source. A plurality of laser sources, which in general may also have different wavelengths, but advantageously have the same wavelength and particularly advantageously are structurally identical, may also be arranged in an “array” and the respectively emitted pump radiation may be combined on the phosphor element. A laser diode is preferred as laser source.

In general, for the first phosphor element, operation either in transmission (pump radiation incidence side opposite to the conversion light emission side) or in reflection (incidence side=emission side) is possible; operation in reflection is preferred, for example for thermal and/or efficiency reasons. The second phosphor element may also be operated in reflection or transmission; combined operation in transmission and reflection is also possible in each case for both the first phosphor element and the second phosphor element.

In the case of the first and/or the second phosphor element, a perpendicular incidence of the respectively exciting radiation is preferred (pump radiation or light having the second spectral component), wherein a centroid direction of the respective beam of rays is taken into consideration in each case. Insofar as reference is made to a “centroid direction” of the light in the context of this disclosure, it is formed as the average value of the vectors of the beam of rays, said vectors being weighted with the respective luminous flux, at the corresponding location in the beam path. The phosphor element may then be assigned an optical unit via which the exciting radiation is focused and also the conversion light is collected; on account of the typically Lambertian emission characteristic, conversion light is then collected the most in the case of perpendicularly incident excitation radiation.

Generally, for guiding conversion light/excitation radiation, it is possible to provide, in a manner assigned to the respective phosphor element, an optical unit which may be imaging or else, for example in the case of a Compound Parabolic Concentrator (CPC), non-imaging.

The coupling-out mirror need not attain the entire conversion light emitted by the first phosphor element, rather there may be a certain loss for example depending on the optical unit used for beam guiding; in general it is not possible for the entire conversion light to be collected. Furthermore, the first conversion light, upstream of the coupling-out mirror, may also be spectrally altered; cf. for example FIGS. 6, 8 with associated description for illustration. The intention is for “at least part” of the first conversion light to arrive at the coupling-out mirror; the part of the first conversion light which arrives at the coupling-out mirror has the first spectral component in the first spectral range and the second spectral component in the second spectral range. Insofar as reference is made to “at least part of the light” generally in this disclosure, this may also mean, depending on the respective construction, for example at least 20%, 40%, 60%, 80% or 90% (with increasing preference in the order in which they are mentioned).

In comparison with the first conversion light originally emitted by the first phosphor element, the part thereof which arrives at the coupling-out mirror may also be spectrally altered. The first and second spectral components may thus together represent the spectral profile of the (original) first conversion light only in part as well; that is to say only constitute a segment thereof, cf. FIG. 1 for illustration. This is because, for example, a deep-red part adjacent to the first spectral range may be cut off for instance on account of a coupling-in mirror explained in detail below. Nevertheless, the light separated by the coupling-out mirror in both spectral ranges still has an intensity, namely the first and the second spectral component (the first and the second spectral component are taken into consideration at the coupling-out mirror); generally, “spectral component” means a spectral intensity.

In preferred embodiments, however, the first conversion light may also pass from the first phosphor element to the coupling-out mirror without being spectrally altered. In other words, the first conversion light then exclusively contains the first and the second spectral component and no components over and above the latter (said components being cut off as described above).

In a preferred embodiment, the first spectral component has a long wavelength in comparison with the second spectral component; thus to put it another way the second spectral component has a shorter wavelength. Therefore, the light of longer wavelength is coupled out and the light of shorter wavelength is guided to the second phosphor element. The second conversion light emitted thereby in response to this excitation has a longer wavelength than the light having the second spectral component; a down-conversion thus takes place. Such a conversion is also generally preferred in the case of the first phosphor element, such that the first conversion light has a longer wavelength than the pump radiation.

The first and second spectral ranges adjoin one another by definition at a limiting wavelength; in the preferred case just presented, the first spectral range then extends away therefrom over longer wavelengths, and the second spectral range over shorter wavelengths. The limiting wavelength is determined according to the optical properties of the coupling-out mirror, that is to say the transition between reflection/transmission.

With further preference, the first conversion light is yellow light, the dominant wavelength of which may be for example at least 570 nm, advantageously at least 575 nm, and for example at most 585 nm, advantageously at most 582.5 nm, more advantageously at most 580 nm (upper and lower limits may also be of interest independently of one another).

For the first phosphor element, as yellow phosphor a garnet phosphor may be preferred, for example yttrium aluminum garnet (YAG) or lutetium aluminum garnet (LuAG), in each case doped with cerium. Exactly one individual phosphor or else a mixture of a plurality of individual phosphors may be provided.

The light having the second spectral component, which is guided to the second phosphor element, is advantageously green light (which is also intended to encompass yellow-green). The dominant wavelength thereof may be for example at least 520 nm, advantageously at least 530 nm, more advantageously at least 535 nm, and for example at most 580 nm, advantageously at most 570 nm, more advantageously at most 565 nm, particularly advantageously at most 560 nm (upper and lower limits may in turn be of interest independently of one another).

The light having the first spectral component is advantageously red light, the dominant wavelength of which is for example at least 580 nm, advantageously at least 585 nm, more advantageously at least 590 nm, particularly advantageously at least 595 nm.

In one preferred embodiment, the red light has a dominant wavelength of, for example, at most 615 nm, advantageously at most 610 nm, more advantageously at most 605 nm, and the second conversion light is deep-red light having a dominant wavelength of at least 605 nm, advantageously at least 610 nm, more advantageously at least 615 nm, particularly advantageously at least 620 nm. The second conversion light may thus spectrally supplement the red light in a certain regard and, for example, help to optimize a color locus that then results upon mixing of the red and deep-red light.

On the other hand, a certain spectral spacing between the second conversion light and the light having the first spectral component may also be of interest insofar as then, for example, with a coupling-in mirror described below, a beam path of the second conversion light can be coupled to an output beam path with the light of the first spectral component; the coupling-in mirror can thus for example transmit the light having the second spectral component and reflect the second conversion light; cf. FIG. 2 for illustration. However, the coupling-in mirror can also “cut off” a certain part of the spectrum of the first conversion light (insofar as there is indeed an overlap with the second conversion light).

The second phosphor element advantageously has a high pump efficiency in the second spectral range and emits deep-red light having a dominant wavelength in the range mentioned above. A europium-doped silicon nitride, for instance of the type (Ca, Sr, Ba)₂Si₅N₈ or of the type CaAlSiN₃, as individual phosphor is preferred; the phosphor element may include either exactly one individual phosphor or else a mixture of a plurality of individual phosphors. An Eu-doped individual phosphor or alternatively an Mn⁴⁺-doped individual phosphor may thus be preferred.

In a preferred embodiment, the coupling-out mirror is transmissive in the first spectral range and reflective in the second spectral range. Therefore, by way of example, a low-pass filter or a band-stop filter may be preferred, wherein in the case of the latter the first and second spectral ranges adjoin one another at the longer of the two limiting wavelengths. The band-stop filter is reflective between the two limiting wavelengths and transmissive again at wavelengths less than the shorter wavelength, for example for a blue channel (see below in detail). The terms “high-pass filter”/“low-pass filter” relate to the energy in the context of this disclosure.

Also independently of whether the coupling-out mirror is reflective in the first or second spectral range, the limiting wavelength at which the first and second spectral ranges advantageously adjoin one another is, with increasing preference in this order, at least 570 nm, 575 nm, 580 nm or 585 nm. Advantageous upper limits are, for example, with increasing preference in this order, at most 610 nm, 605 nm, 600 nm or 595 nm; upper and lower limits may also be of interest independently of one another. In other words, the limiting wavelength or one of the limiting wavelengths of the coupling-out mirror thus lies in a corresponding range.

In one preferred embodiment, the second conversion light is guided jointly with the light having the first spectral component to the same output; the light having the first spectral component, downstream of the coupling-out mirror, is present in an “output beam path”. The beam path of the second conversion light is coupled thereto and for this purpose advantageously already upstream of the coupling-out mirror is guided along a beam path which contains the light having the first spectral component.

As explained further in detail below, the beam path of the second conversion light may be coupled to the beam path of the light having the first spectral component by means of a coupling-in mirror, for example. On the other hand, the first and second phosphor elements may for example also be provided in a manner directly adjoining one another and the second conversion light emitted at this interface from the second phosphor element through the first may be guided jointly with the first conversion light emitted by the first phosphor element at its side opposite to the interface.

At the output of the lighting device, generally in a preferred embodiment, a surface light modulator may be arranged, with which an image can be modulated onto a beam of rays by means of pixel-dependent forwarding (or non-forwarding). The “forwarding” may be effected by reflection or transmission. Thus, by way of example, a micromirror array (digital micromirror device, DMD array) or a liquid crystal-based image generator, for instance an LCD (Liquid Crystal Display) or LCoS (Liquid Crystal on Silicon) image generator may be provided.

Generally, one preferred embodiment concerns a first and a second phosphor element which are provided in a direct optical contact with one another, either directly adjoining one another or spaced apart from one another by way of an interspace, which is advantageously free of optically active gas volumes, cf. FIG. 6 for illustration. In a corresponding interspace, therefore, by way of example, at most an optical glass is intended to be arranged; by way of example, at most materials having a refractive index n≧1.2, advantageously≧1.3, are intended to be provided in a possible interspace (considered in each case at λ=580 nm).

Generally, a layer form is preferred for the phosphor elements, that is to say that they have in each case in the layer directions an extent greater, for instance at least by 5-, 10-, 15-, 20- or 25-fold, than perpendicular thereto, in a thickness direction. Possible upper limits may be for example at most 100-, 70-, 50- or 35-fold. The extent in the layer directions may be for example between 1 mm and 3 mm, and the thickness between 100 μm and 200 μm.

Relative to the layer directions, the phosphor elements may advantageously be provided congruently. Incidence and emission sides are advantageously on the exterior relative to the thickness direction, on the same side in the case of operation in reflection and on opposite sides in the case of operation in transmission; incidence and emission sides may extend for example in each case perpendicular to the thickness direction.

As already mentioned, in preferred embodiments, the beam path having the second conversion light is coupled to the beam path of the first conversion light by means of a coupling-in mirror, cf. for example FIGS. 2 to 5 for illustration.

The coupling-in mirror may either be transmissive for the first conversion light (at least part thereof) and reflect the second conversion light or be reflective for the first conversion light (at least part thereof) and transmit the second conversion light. A corresponding limiting wavelength of the coupling-in mirror may be for example at least 600 nm, advantageously at least 610 nm, more advantageously at least 615 nm, and for instance at most 630 nm, advantageously at most 625 nm; upper and lower limits may also be of interest independently of one another. The first spectral range may then extend for example from an abovementioned limiting wavelength of the coupling-out mirror to a just mentioned limiting wavelength of the coupling-in mirror.

Advantageously, the coupling-in mirror is transmissive for the first conversion light and reflective for the second conversion light. Unlike in the above-described variant with phosphor elements lying one directly on top of another, the second conversion light in the present case generally penetrates through a gas volume (inert gas or advantageously air) before it impinges on the coupling-in mirror.

Relative to a centroid direction, which the beam path having the first conversion light has where coupling-in takes place, a coupling-in mirror tilted by 45° with respect to said centroid direction may be preferred (wherein the tilting angle is taken between the direction and an axis penetrating perpendicularly through the advantageously planar coupling-in mirror surface), cf. FIGS. 2, 3 for illustration. On the other hand, the angle may also be less than 45°, for example in order to realize a more compact construction overall, cf. FIG. 4 for illustration. It may also be preferred for the coupling-in mirror and the coupling-out mirror to be provided as an integrated component, for example as a so-called X-Cube having two mirror surfaces perpendicular to one another, cf. FIG. 5 for illustration. This last may also help to increase the packing density.

In preferred embodiments, the second phosphor element is operated in transmission, that is to say that the excitation light (the light having the second spectral component) is incident on an incidence side and the second conversion light is guided away from an emission side opposite to said incidence side. For illustration, reference is made to FIGS. 9 and 10.

With further preference, a decoupling mirror may be arranged between the first and second phosphor elements, wherein “between” relates to the beam path of the light having the second spectral component from the first phosphor element to the incidence side of the second phosphor element. The decoupling mirror is reflective in the first spectral range and transmissive in the second spectral range, that is to say allows the excitation light (for the second phosphor element) to pass through. Light having the second spectral component that is returned from the coupling-out mirror is transmitted for example through the first phosphor element and the decoupling mirror to the second phosphor element.

In one preferred embodiment, the decoupling mirror between the first and second phosphor elements is provided in direct optical contact (for definition see above), with at least one of the two phosphor elements, advantageously with both. A layer construction including a transparent substrate body, for instance glass or sapphire, may be particularly preferred, wherein the two phosphor elements, the decoupling mirror and the substrate body are then advantageously provided such that closest adjacent layers directly adjoin one another and the decoupling mirror lies in this layer sequence precisely between the two phosphor elements.

One preferred embodiment concerns a second phosphor element arranged upstream of the coupling-out mirror in the beam path of the first conversion light, cf. FIG. 7 for illustration. Relative to the beam path of the first conversion light from the first phosphor element to the coupling-out mirror, the second phosphor element is thus arranged between the two in this case. Before the first conversion light reaches the coupling-out mirror, it penetrates through the second phosphor element, wherein part of the light having the second spectral component is already converted. Consequently, the non-converted part of the light having the second spectral component, which may make up for example at least 30%, advantageously at least 40% (in relation to the converted part), passes to the coupling-out mirror.

Upon passage through the second phosphor element, part of the light having the first spectral component may also be lost, for example as a result of scattering. Advantageously, however, at least 70%, more advantageously at least 80% or 90%, thereof arrives at the coupling-out mirror. Even if, upon passage through the second phosphor element, the ratio of the spectral components thus changes, the light still contains first conversion light (see above).

In the embodiment, the coupling-out mirror guides the non-converted part of the light having the second spectral component back to the second phosphor element, where it is then converted at least partly, advantageously completely. The second conversion light emitted in response to the excitation is emitted partly toward the coupling-out mirror, but generally also in an opposite direction (toward the first phosphor element). If the second conversion light is spectrally offset to a certain extent with respect to the light having the first spectral component for example deep-red to red (see above), the side of the second phosphor element that faces the first phosphor element may also be provided with a wavelength-dependent mirror that is reflective for the second conversion light, but transmissive in the first and second spectral ranges.

In general, the first phosphor element may also be provided in a static fashion. However, one preferred embodiment concerns a first phosphor element which is provided on a rotary body mounted rotatably about a rotation axis. In general, a phosphor roller is also conceivable, for example, on the lateral surface of which the phosphor element may be arranged, but preference is given to a phosphor wheel, wherein the rotation axis is advantageously perpendicular to an arrangement surface with the phosphor element. In the case of a phosphor element in layer form, the layer directions are then thus perpendicular to the rotation axis.

Advantageously, together with the first phosphor element on the rotary body provision is then also made of a further phosphor element of a different color for a further channel, particularly advantageously green, and/or a segment for a blue channel. Blue pump light is advantageously used for the blue channel, which blue pump light may supply the blue channel either by itself or in a mixture with a conversion light; in the last-mentioned case, the blue pump light would then be converted in the blue segment only partly by a corresponding phosphor element.

In a preferred embodiment, a phosphor wheel having the first phosphor element, in a different segment corresponding to the blue channel, is provided with a passage. A phosphor operated in transmission and with partial conversion could also be arranged in said passage, but the blue pump light advantageously passes through the passage without conversion. Therefore, by way of example, a transparent main body may form an optical passage or a main body, which is then advantageously not transparent, may be provided with an actual through opening (cut-out).

Downstream of the passage, the pump light may then be deflected by optical elements, for example at least two mirrors, such that it has a direction opposite to its original propagation direction (in the passage). It is then guided either past the phosphor wheel or through a further passage, which may be offset with respect to the first-mentioned passage by a 180° rotation. Since the other channels are advantageously operated in reflection, the blue pump light as blue channel is then also available together with the other channels at the front side of the phosphor wheel.

In one preferred embodiment, cf. for example FIG. 8 for illustration, the lighting device is provided such that in a rotary position in which the first phosphor element is excited, the light having the second spectral component is guided on the rear side of the phosphor wheel to the second phosphor element, which is advantageously arranged on the rear side of the phosphor wheel (the rear side is opposite to the front side having the phosphor element). With further preference, this is carried out by means of the same optical elements (advantageously at least two mirrors) as in the case of the blue channel, that is to say if, in a different rotary position, blue pump light penetrates through the phosphor wheel through two passages and is thus guided toward the front again.

In the case of a phosphor wheel having a main body, it may generally be preferred for the first phosphor element to be arranged on one side of the main body and the second phosphor element on the other side thereof (in each case in a manner connected to the main body), such that the phosphor elements thus lie on different sides of the main body relative to directions parallel to the rotation axis. This may be combined for example with the above-described variant in accordance with which the first and second phosphor elements are provided in direct optical contact; on the other hand, the light having the second spectral component, between the two phosphor elements, may also penetrate through a gas volume, for instance inert gas or advantageously air, and be guided via an optical unit just described (which not necessarily but advantageously is also used for pump light). The main body may also be reflective (for instance composed of/including metal) and provided locally with passages.

In a preferred embodiment, therefore, the second phosphor element is also provided on a rotary body, particularly advantageously jointly with the first phosphor element on the same rotary body, cf. the examples just described. On the other hand, the second phosphor may also be arranged on a dedicated rotary body that rotates in a manner clocked cyclically, advantageously synchronously with that of the first phosphor element. With regard to possible embodiments of such a rotary body, reference is made to the above disclosure.

Equally, an arrangement of the coupling-out mirror on a rotary body may also be preferred (and with regard to possible embodiments of the “rotary body”, reference is once again made to the above disclosure). With further preference, the coupling-out mirror shares the rotary body with the first and/or second phosphor element, particularly with both. By way of example, therefore, then the coupling-out mirror is arranged on one side of the first phosphor element and the second phosphor element is arranged on the other side thereof; advantageously these constituent parts are then provided in direct optical contact with one another and more advantageously with a substrate body of the rotary body/phosphor wheel.

In a preferred embodiment, the coupling-out mirror is transmissive or reflective for the pump radiation, advantageously blue pump light, to be precise inversely with respect to the second spectral range. If the coupling-out mirror is thus transmissive in the second spectral range, it is then reflective for the pump radiation, whereas it transmits the latter if it reflects the light having the second spectral component. Pump radiation guided along the beam path of the second conversion light to the coupling-out mirror (at a different point in time, as a different channel) is intended thus to be guided via the coupling-out mirror, that is to say be coupled out, like the light having the first spectral component.

The present disclosure also relates to the use of a lighting device described in the present case for illumination with a mixture of the light having the first spectral component and the second conversion light. Besides the projection applications already mentioned, that is to say for instance use as part of a projection apparatus, advantageous fields of application may generally be in the area of lighting technology. By way of example, a use in the area of automotive lighting or in medical illumination/irradiation apparatuses is also conceivable; furthermore, a corresponding light source may for example also be part of an effect light apparatus.

### BRIEF DESCRIPTION OF THE DRAWINGS

The present disclosure is explained in greater detail below on the basis of exemplary embodiments, wherein the individual features in the context of the alternative independent claims may also be essential to the present disclosure in a different combination and, furthermore, no distinction is also drawn specifically between the claim categories.

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic diagram of a spectrum for illustrating the concept according to the present disclosure;

FIG. 2 shows a first lighting device according to the present disclosure including two phosphor elements arranged at a distance from one another, said phosphor elements being operated in each case in reflection;

FIG. 3 shows a second lighting device according to the present disclosure, the basic construction of which corresponds to that of the lighting device in accordance with FIG. 2, but is optimized for a more efficient utilization of the second conversion light;

FIG. 4 shows a third lighting device according to the present disclosure, the basic construction of which corresponds to that of the lighting device in accordance with FIG. 3, but is optimized toward a more compact arrangement;

FIG. 5 shows a fourth lighting device according to the present disclosure, the basic construction of which corresponds to those of the lighting devices in accordance with FIGS. 3 and 4, but is realized with an integrated coupling-out/coupling-in mirror element;

FIG. 6 shows a fifth lighting device according to the present disclosure, in which the two phosphor elements are provided in direct optical contact with one another;

FIG. 7 shows a sixth lighting device according to the present disclosure including a first phosphor element operated in reflection and a second phosphor element arranged at a distance therefrom;

FIG. 8 shows a seventh lighting device according to the present disclosure including a first phosphor element operated partly in reflection, partly in transmission, and a second phosphor element arranged at a distance therefrom and operated in reflection;

FIG. 9 shows an eighth lighting device according to the present disclosure including a first phosphor element operated in reflection and a second phosphor element provided in direct optical contact therewith and operated in transmission;

FIG. 10 shows a ninth lighting device according to the present disclosure, the basic construction of which corresponds to that of the lighting device in accordance with FIG. 9, but in which the coupling-out mirror is provided at a distance from the first phosphor element.

### DETAILED DESCRIPTION

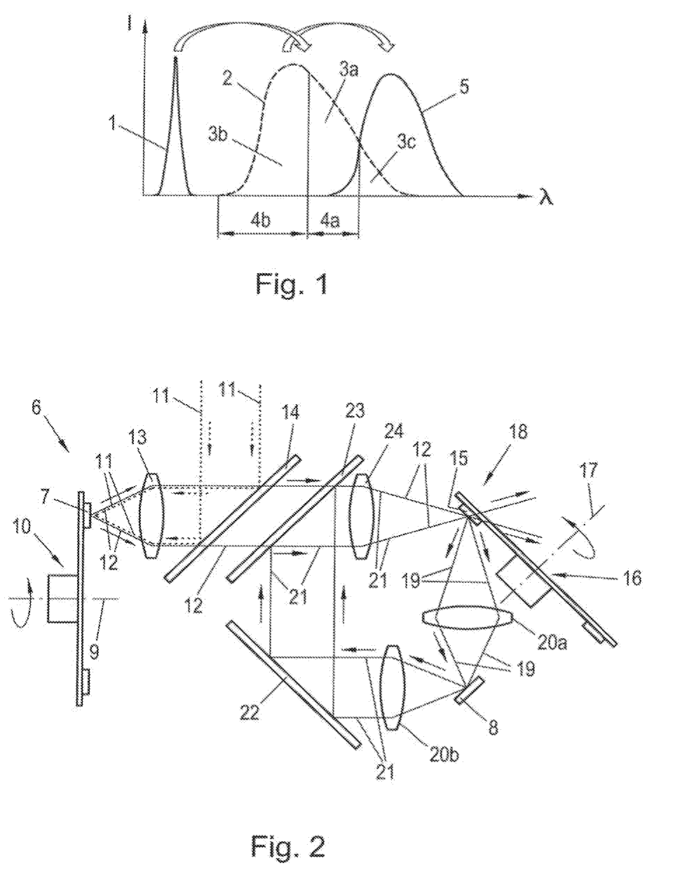

FIG. 1 shows, in a schematic diagram, spectra for illustrating the concept of the present disclosure. The short-wave pump radiation 1, namely blue pump light having a dominant wavelength of approximately 450 nm, is converted into yellow broadband conversion light 2 by a first phosphor element (YAG:Ce). For the red channel of a multi-channel light source, however, it is possible to use thereof only a first spectral component 3a in a first spectral range 4a, that is to say the component in the red. If this were achieved merely by filtering, a second spectral component 3b in a second spectral range 4b would remain unused.

The present approach now consists in firstly using the first spectral component 3a directly as red light and making the second spectral component 3b, separated therefrom for this purpose, likewise usable for the red channel, to be precise by means of a renewed conversion. With the second spectral component 3b, that is to say the green/yellow-green light, a second phosphor element (EU-doped Ca, Sr, Ba)₂Si₅N₈) is excited, which emits a second, deep-red conversion light 5 in response to this excitation. Said conversion light is usable jointly with the light having the first spectral component 3a for the red channel.

The yellow broadband conversion light 2 also has another spectral component 3c at lower energies relative to the first spectral component 3a, namely in the deep-red. Although this component could also be used for the red channel, it is cut off as explained below with reference to FIG. 2.

FIG. 2 then shows a first corresponding lighting device 6 including a first phosphor element 7 and a second phosphor element 8. The first phosphor element 7 is provided on a phosphor wheel 10 mounted rotatably about a rotation axis 9, said phosphor wheel being shown in a schematic section in the figure (the sectional plane includes the rotation axis 9).

At the point in time shown in FIG. 2, that is to say at the shown rotary position of the phosphor wheel 10, a beam path 11 of the pump radiation is incident on the first phosphor element 7, which emits the first conversion light (yellow broadband conversion light) in response to this excitation. The first phosphor element 7 is operated in reflection, and a beam path 12 of the first conversion light is guided in sections along the beam path 11 of the pump radiation (in the opposite direction). By means of a first optical unit 13, illustrated schematically as a converging lens in the present case, firstly the pump radiation is focused onto the first phosphor element 7 and secondly the first conversion light emitted divergently with a Lambertian emission characteristic is collimated.

A wavelength-dependent pump radiation mirror 14 positioned downstream of the first optical unit 13 relative to the first conversion light is reflective for the pump radiation, but transmits the first conversion light. The latter penetrates through a further wavelength-dependent mirror (which in this respect is likewise transmissive), explained in detail below, and is focused onto a coupling-out mirror 15. Said coupling-out mirror 15 is mounted rotatably in a manner comparable with the first phosphor element 7, specifically on a filter wheel 16 (the sectional plane once again contains the rotation axis 17).

The coupling-out mirror 15 is transmissive in the first spectral range 4a but reflective in the second spectral range 4b. Therefore, the first spectral component 3a of the first conversion light is transmitted and is available as red light at an output 18 of the lighting device 6. On account of the wavelength-dependent mirror 23, however, the entire first conversion light does not arrive at the coupling-out mirror 15, rather a deep-red component 3c is reflected out of the beam path, cf. FIG. 1.

The light having the second spectral component 3b, that is to say green light, is reflected at the coupling-out mirror 15. The second phosphor element 8 is arranged in a beam path 19 of the light having a second spectral component; the light having the second spectral component is focused thereon, specifically by means of a first phosphor element optical unit 20a assigned to the second phosphor element 8. The second conversion light thereupon emitted thereby is collimated by means of a second phosphor element optical unit 20b. In this case, the entire second conversion light is not collected, but rather only the part at a corresponding solid angle.

A coupling-in mirror 23 is arranged in a beam path 21 of the second conversion light, which beam path is guided via a mirror (full reflective coating) 22, said coupling-in mirror being reflective for the second conversion light, but transmissive for the first conversion light apart from the deep-red component thereof. The light having the first spectral component has a dominant wavelength of approximately 600 nm, and the second conversion light has a dominant wavelength of more than 620 nm. Ideally, the spectra do not overlap (in contrast to what is shown in FIG. 1) and the coupling-in mirror 23 is transmissive for the entire first conversion light.

Downstream of the coupling-in mirror 23, the beam path 21 of the second conversion light extends along the beam path 12 of the first conversion light, that is to say is focused jointly with the latter onto the coupling-out mirror 15 by means of a focusing optical unit 24. Said coupling-out mirror is not only transmissive in the first spectral range, but as a low-pass filter is then generally transmissive at longer wavelengths, that is to say that the second, deep-red conversion light is coupled out jointly with the red light; an output beam path is present downstream of the coupling-out mirror 15.

At a different point in time than that shown in the figure, the phosphor wheel 10 may then have rotated further somewhat and a different phosphor element than the first phosphor element 7 may be excited, for example for emitting green conversion light, which may then pass through both the pump radiation mirror 14 and the coupling-in mirror 23 in transmission. The filter wheel 16 has then also rotated further in a manner corresponding to the phosphor wheel 10, such that the green conversion light is not incident on the coupling-out mirror 15 and green light is present at the output 18.

To summarize, therefore, the wavelength-dependent pump radiation mirror 14 is reflective for the pump radiation, but transmissive for the rest; its limiting wavelength may be 460 nm, for example. The coupling-in mirror 23 is transmissive up to a limiting wavelength of approximately 620 nm, and is reflective thereabove, that is to say at lower energies (high-pass filter). The coupling-out mirror 15 is a low-pass filter having a limiting wavelength at approximately 590 nm, which thus transmits longer-wavelength (red and deep-red) light with respect thereto.

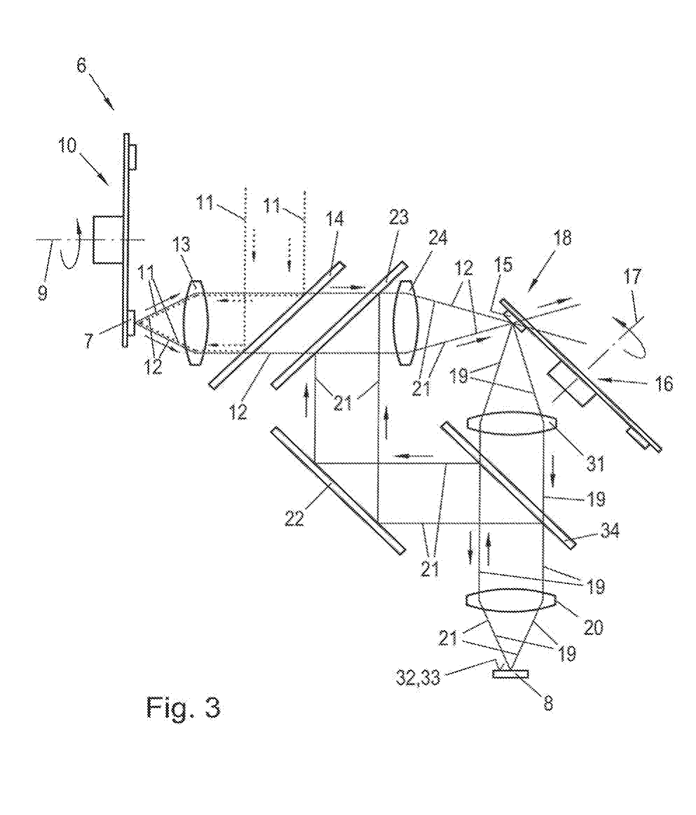

FIG. 3 shows a further lighting device 6 according to the present disclosure, which in terms of its basic construction corresponds to the lighting device in accordance with FIG. 2. In this respect and generally, the same reference signs designate parts having the same function and reference is then also made in each case to the corresponding description of the other figures.

The first conversion light emitted by the first phosphor element 7 in response to the excitation with the pump radiation is in turn guided to the coupling-out mirror 15, which transmits the red component to the output 18 and reflects the green component to the second phosphor element 8. The latter is thus in turn arranged in a beam path 19 of the light having the second spectral component, but the beam guidance differs from that of the lighting device 6 in accordance with FIG. 2.

This is because the green light reflected divergently from the coupling-out mirror 15 is firstly collimated by means of a collimation optical unit 31 and is then focused onto the second phosphor element 8 via the phosphor element optical unit 20. In this case, a centroid direction of the excitation light, that is to say of the green light, is perpendicular to the second phosphor element 8, that is to say to the incidence side 32 thereof. The second phosphor element 8 is operated in reflection; the incidence side 32 is identical to the emission side 33. The second conversion light is guided via the same phosphor element optical unit 20, wherein, on account of the arrangement thereof with the optical axis parallel to a main emission direction, the second conversion light is collected from a solid angle range in which the light intensity is the highest on account of the Lambertian emission characteristic.

In order then to decouple the collected second conversion light from the beam path 19 of the light having the second spectral component (of the green light), a conversion light mirror 34 is provided downstream of the phosphor element optical unit 20, said conversion light mirror being transmissive in the second spectral range, but reflecting the second conversion light. Downstream thereof, the beam path then once again corresponds to that of the lighting device 6 in accordance with FIG. 2; the second, deep-red conversion light is available jointly with the red light at the output 18.

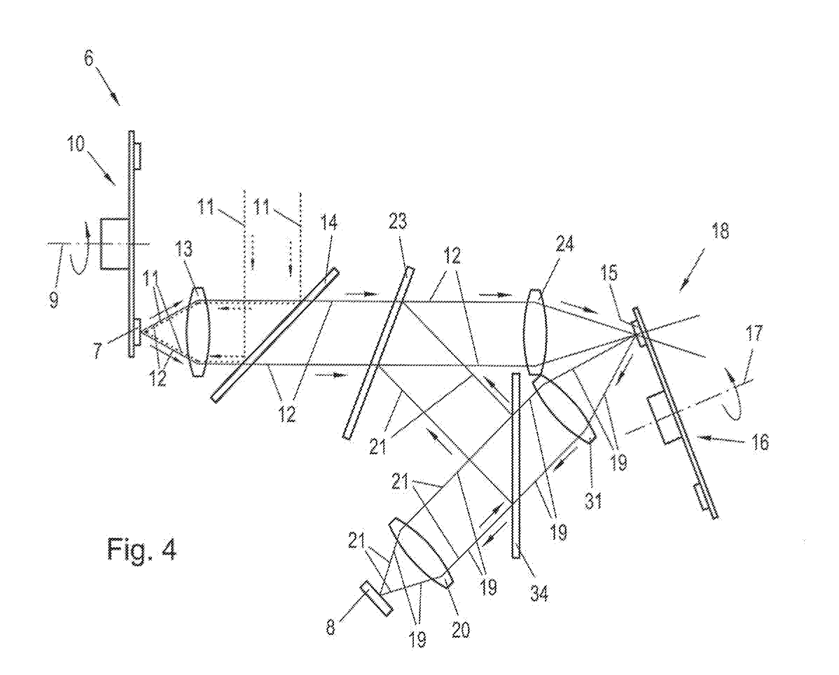

The lighting device 6 in accordance with FIG. 4 corresponds in principle to that in accordance with FIG. 3, just the angle between the beam path 19 of the light having the second spectral component, that is to say of the reflected green light, and the beam path 12 of the first conversion light at the coupling-out mirror 15 is smaller; the first conversion light (a centroid direction thereof) impinges on the coupling-out mirror 15 more steeply, that is to say at a smaller angle with respect to an axis perpendicular to the coupling-out mirror 15. In the case of the lighting devices 6 in accordance with FIGS. 2 and 3, the angle between centroid direction of the first conversion light and axis was 45°, that is to say that the angle between the two centroid directions (of the first conversion light and of the light having the second spectral component) was correspondingly 90°.

In the present case, said angle is smaller and the collimation optical unit 31 and the entire downstream part with the second phosphor element 8 accordingly move nearer to the beam path 12 of the first conversion light. This may enable a more compact construction. Moreover, the second conversion light downstream of the conversion light mirror 34 is not additionally guided via a dedicated mirror 22, but rather is guided directly to the coupling-in mirror 23, which in this respect necessitates one component fewer.

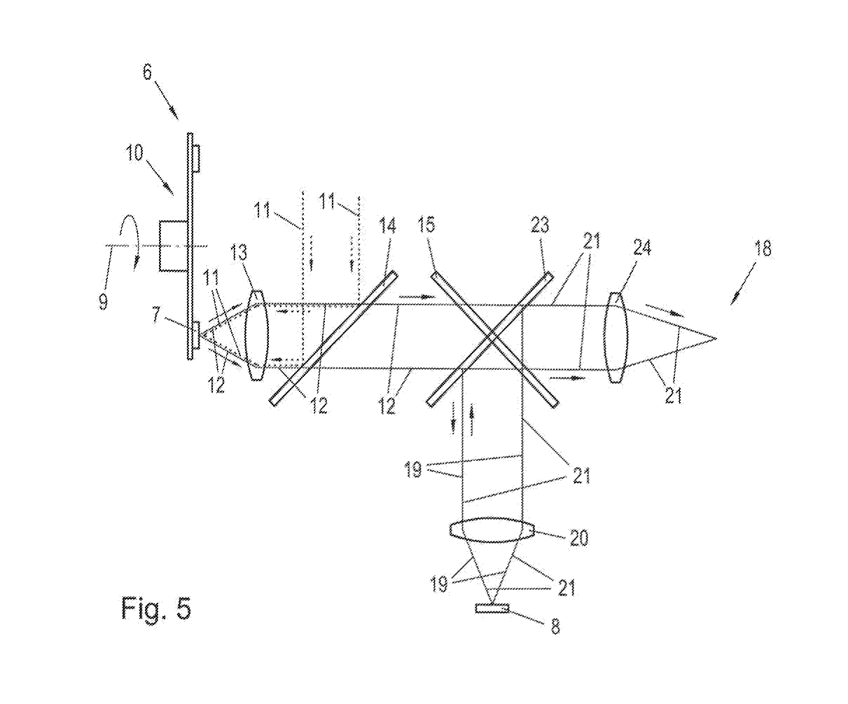

The lighting device 6 in accordance with FIG. 5 is also optimized with regard to the space requirement. In contrast to the previous lighting devices 6, in this case the coupling-out mirror 15 is not arranged on a filter wheel 16, but rather is provided jointly with the coupling-in mirror 23 in an integrated component, namely a so-called X-Cube. The two mirrors 15, 23 thus cross one another, and the beam path 19 of the green light (the light having the second spectral component) and the beam path 21 of the second conversion light run away from the X-Cube and toward the latter along the same path.

In the X-Cube, the light having the first spectral component is transmitted by both mirrors 15, 23 (the coupling-in mirror 23, which is reflective for the deep-red second conversion light, is also transmissive up to approximately 620 nm, see above), but the light having the second spectral component (green light) is reflected from the coupling-out mirror 15 to the phosphor element optical unit 20. The second, deep-red conversion light emitted by the second phosphor element 8 in response to the excitation is reflected at the coupling-in mirror 23 and is available jointly with the red light at the output 18 of the lighting device 6. The coupling-out mirror 15 may also be designed in a more complex manner with regard to other channels, for instance as a band-stop filter, in order for example to be transmissive for a blue channel (at a different point in time).

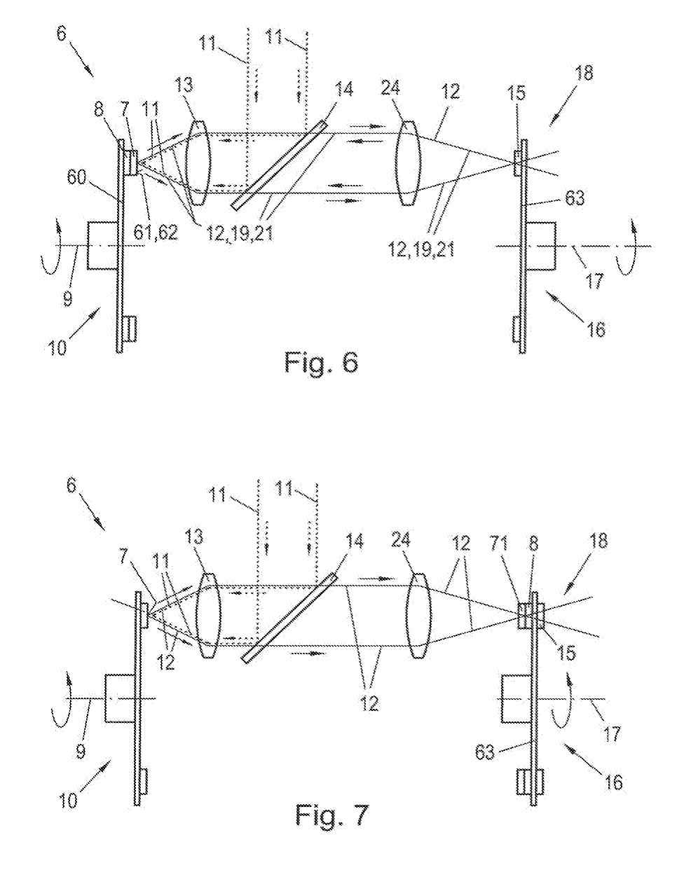

The lighting device 6 in accordance with FIG. 6 differs fundamentally from the embodiments discussed previously insofar as the two phosphor elements 7, 8 previously were provided in a manner spaced apart from one another via an air gap. By contrast, in the case of FIG. 6, they are provided in direct optical contact, to be precise one on top of another. The first phosphor element 7 is in turn provided on a phosphor wheel 10, but the second phosphor element 8 is arranged between a substrate body 60 of the phosphor wheel 10 and the first phosphor element 7. Therefore, the second phosphor element 8 is applied to the substrate body 60 and the first phosphor element 7 is then applied to the second phosphor element 8.

In response to the excitation with the pump radiation, the first phosphor element 7 emits the first conversion light, to be precise in principle omnidirectionally, that is to say in substantially equal parts at an incidence side 61, which in the present case is also simultaneously an emission side 62, and a rear side opposite thereto. The second phosphor element 8 is provided in a manner adjoining the latter. Such omnidirectional emission behavior is exhibited in general by the phosphor elements 7, 8 discussed in the present case; the fact of whether the conversion light is guided away at an emission side 62 opposite to the incidence side 61 (transmission) or indeed in reflection then depends on the specific arrangement.

In the case of the lighting device 6 in accordance with FIG. 6, a beam path 12 of the first conversion light emitted at the emission side 62 of the first phosphor element 7 (toward the right in the figure) is in turn focused onto a coupling-out mirror 15 provided on a filter wheel 16. The light having the first spectral component is transmitted thereby and is available as red light at the output 18. However, the coupling-out mirror 15 arranged on a substrate body 63 reflects the light having the second spectral component, that is to say the green light, to be precise back along the same path.

The green light passes through the wavelength-dependent pump radiation mirror 14, which is thus designed as a low-pass filter having a limiting wavelength between the pump radiation and the broadband conversion light (e.g. at 460 nm). The green light is then incident on the first phosphor element 7 and penetrates through the latter, apart from possible scattering losses, to the second phosphor element 8, where the green light is converted into second, deep-red conversion light, which is guided by the first phosphor element 7 along the beam path 12 of the first conversion light to the wavelength-dependent coupling-out mirror 15 and passes through this low-pass filter, which has its limiting wavelength at approximately 590 nm, and is available at the output 18.

First conversion light emitted by the first phosphor element 7 at its rear side, opposite to the emission side 62, to the second phosphor element 8 is partly converted by the second phosphor element 8 into deep-red light, which then passes to the coupling-out mirror 15 in the manner just described. The light having the first spectral component, that is to say the red light, penetrates through the second phosphor element 8, apart from scattering, etc., and is reflected at the substrate body 60, which is provided with a specularly reflective surface in order to increase the efficiency, in the direction of the emission side 62 and passes from there via the coupling-out mirror 15 to the output 18.

In the case of the lighting device 6 in accordance with FIG. 7, the two phosphor elements 7, 8 are arranged once again in a manner spaced apart from one another, wherein the second phosphor element, in contrast to the embodiments in accordance with FIGS. 2 to 5, is arranged directly in the beam path 12 of the first conversion light. The second phosphor element 8 is arranged jointly with the coupling-out mirror 15 on the filter wheel 16, to be precise in direct optical contact with the coupling-out mirror 15 on the other side of the transparent main body 63, namely upstream of the coupling-out mirror 15.

During passage through the second phosphor element 8, part of the green light contained in the first conversion light is already converted into deep-red light (partial conversion); the transmitted, non-converted part impinges jointly with the rest of the first conversion light on the coupling-out mirror 15. The latter in turn transmits the red light to the output 18, but reflects the light having the second spectral component, that is to say the green light. The latter impinges on the phosphor element 8, which emits second, deep-red conversion light in response to the excitation.

The deep-red light emitted by the second phosphor element 8 in its side facing the coupling-out mirror 15 passes through the coupling-out mirror 15 jointly with the red light. The deep-red light emitted at the opposite side of the second phosphor element 8 may be guided to the first phosphor element 7 and reflected by it on the rear side thereof, that is to say then back to the coupling-out mirror 15 again. In order to avoid scattering losses here, the rear side of the second phosphor element 8 may, however, also be reflectively coated, namely with an (optional) high-pass filter 71 having a limiting wavelength at approximately 620 nm.

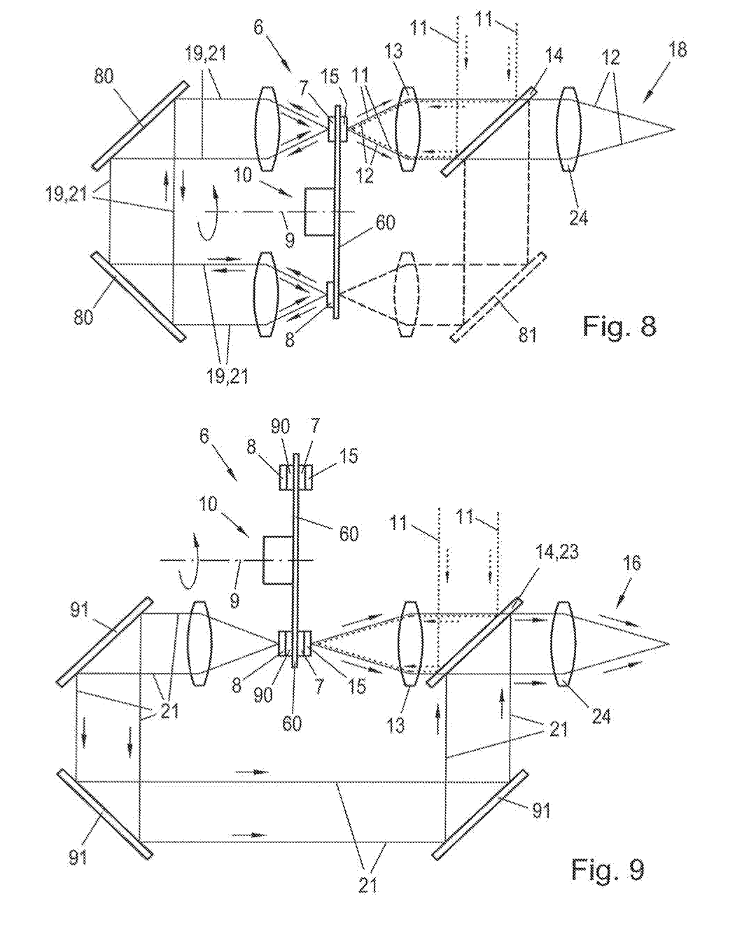

In the case of the lighting device 6 in accordance with FIG. 8, the two phosphor elements 7, 8 and the coupling-out mirror 15 are arranged on the same phosphor wheel 10, but the two phosphor elements 7, 8 are nevertheless spaced apart from one another. This is because the first 7 and the second phosphor element 8 extend in each case in a dedicated segment, which segments lie on opposite sides relative to the rotation axis 9. Looking at the phosphor wheel 10 along the rotation axis 9, the arrangement is rotationally symmetrical insofar as one segment can be converted into the other segment by a rotation by 180° (about the rotation axis 9).

Relative to the pump radiation, the coupling-out mirror 15 is arranged upstream of the first phosphor element 7, namely in direct optical contact with the first phosphor element 7. The pump radiation penetrates through the coupling-out mirror, which is designed as a band-stop filter in this case, and is incident on the first phosphor element 7. The first conversion light emitted thereby in response to the excitation is separated by the coupling-out mirror 15, which in turn reflects the green light and transmits the red light (the band-stop filter is reflective in the stop band). The side of the first phosphor element 7 opposite to the coupling-out mirror 15 is optionally provided with a mirror (not illustrated in the present case) which is transmissive in the second spectral range, that is to say transmits the green light; however, red light (the light having the first spectral component) is reflected thereby and guided to the coupling-out mirror 15.

On the rear side of the first phosphor element 7, the beam path 19 of the green light is guided via an optical unit, in the present case two mirrors 80 (full reflective coating), to the second phosphor element 8. The second, deep-red conversion light emitted by the second phosphor element 8 in response to the excitation is then guided back via the same optical unit 80, penetrates through the optional mirror on the rear side of the first phosphor element 7 (which mirror is again transmissive in the deep-red as a band-stop filter) and also the first phosphor element 7 and passes through the coupling-out mirror 15. The deep-red light is then available jointly with the red light at the output 18.

In order to supply a blue channel using the lighting device 6 in accordance with FIG. 8 at a different point in time than as shown, the phosphor wheel 10 is provided in a corresponding section with two segments embodied as passages. The blue pump light can pass through these passages, that is to say that the main body 60 of the phosphor wheel 16 may be provided with corresponding slots, for example. Downstream of the first passage, that is to say on the rear side of the phosphor wheel 16, the blue pump light is then guided via the same optical unit 80 as the green light before it passes through the phosphor wheel 16 though the second passage. On the front side of the phosphor wheel (dashed) it may then be directed by a mirror 81 to the pump radiation mirror 14 and be reflected by the latter to the output 18.

In the embodiment in accordance with FIG. 9, too, the two phosphor elements 7, 8 are arranged on the same phosphor wheel 10, but in direct optical contact with one another; the light thus does not pass through an air gap therebetween in contrast to the arrangement just described. The pump radiation is once again incident on the first phosphor element 7 through the coupling-out mirror 15. From that part of the first conversion light which is emitted toward the coupling-out mirror 15, the coupling-out mirror reflects the green light, that is to say the light having the second spectral component; the red light is transmitted to the output 16.

A decoupling mirror 90 is arranged between the two phosphor elements 7, 8, that part of the first conversion light which is emitted toward the other side impinging on said decoupling mirror. Said decoupling mirror 90 is a high-pass filter having a limiting wavelength at approximately 590 nm, that is to say transmits the green component of the first conversion light and reflects the red component; the latter is available at the output 16. On the other hand, the green light passes through the decoupling mirror 90, to be precise both green light originally emitted in this direction and green light previously reflected at the coupling-out mirror 15.

The second phosphor element 8 is arranged downstream of the decoupling mirror 90, said second phosphor element emitting the second, deep-red conversion light in response to the excitation. The beam path 21 of the deep-red light is guided by an optical unit 91 around the phosphor wheel 16 and is coupled to the beam path of the red light, that is to say to the output beam path, by the pump radiation mirror 14, which is simultaneously a coupling-in mirror 23. The mirror 14, 23 is provided for this purpose as a bandpass filter, that is to say is transmissive between two limiting wavelengths at approximately 460 nm and 620 nm, but is reflective therebelow (for the pump radiation) and thereabove (for the deep-red light).

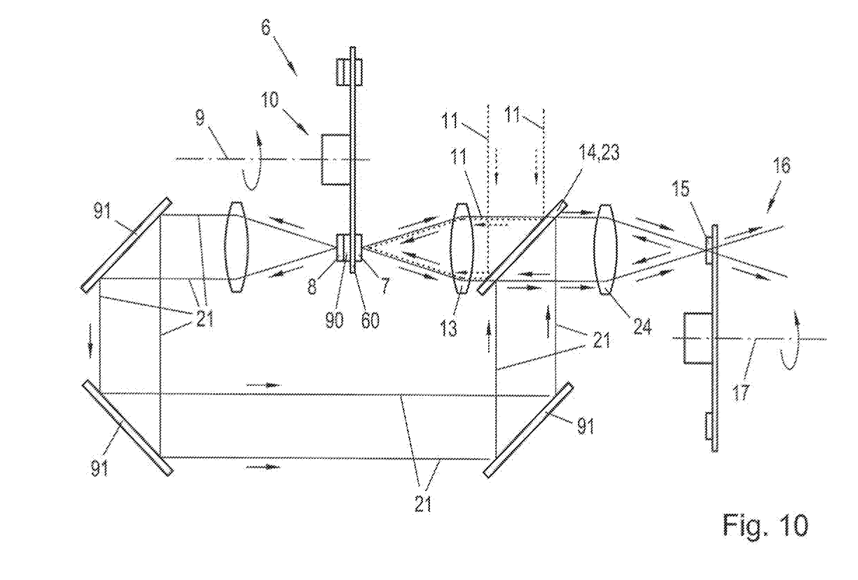

In the case of the embodiment in accordance with FIG. 10, too, the two phosphor elements 7, 8 are provided in direct optical contact with one another on the same phosphor wheel 10. Equally, a decoupling mirror 90 that is transmissive in the second spectral range is provided between the two phosphor elements 7, 8, and the beam path 21 of the deep-red, second conversion light also corresponds to that in the case of the embodiment in accordance with FIG. 9.

In contrast thereto, however, in the case of the embodiment in accordance with FIG. 10 the coupling-out mirror 15 is not arranged on the same phosphor wheel 10, but rather at a distance therefrom on a dedicated filter wheel 16. First conversion light emitted by the first phosphor element 7 toward the coupling-out mirror 15 (toward the right in the figure) partly passes through the coupling-out mirror 15, that is to say that once again the red light is transmitted to the output 16, but the green light is reflected back.

The latter penetrates through the combined pump radiation/coupling-in mirror 14, 23, which as a bandpass filter is transmissive between approximately 460 nm and 620 nm, penetrates through the first phosphor element and is also transmitted by the decoupling mirror 90; the green light thus passes to the second phosphor element 8. The second conversion light emitted thereby in response to this excitation is guided in the manner as explained with reference to FIG. 9.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lighting device comprising
a pump radiation source for emitting pump radiation,
a first phosphor element for converting the pump radiation into a first conversion light,
a second phosphor element for generating a second conversion light, and a coupling-out mirror, which is arranged downstream of the first phosphor element in a beam path with at least part of the first conversion light,
wherein the first conversion light is a broadband conversion light having components in a first spectral range and a second spectral range, which is different from the first spectral range,
wherein the coupling-out mirror arranged in the beam path with at least part of the first conversion light is transmissive only in one of the two spectral ranges but is reflective in the other spectral range, such that, downstream of the coupling-out mirror, light having a first spectral component in the first spectral range and light having a second spectral component in the second spectral range are present in a separated fashion, wherein at least part of the light having the first spectral component is available at an output of the lighting device, and wherein the second phosphor element is arranged in a beam path with at least part of the light, separated by the coupling-out mirror, having the second spectral component and, in response to this excitation, emits the second conversion light, which can be used jointly with the light having the first spectral component in order to increase the efficiency.

2. The lighting device as claimed in claim 1, wherein the light having the second spectral component, with which the second phosphor element is excited, has a shorter wavelength than the light having the first spectral component, and the second conversion light emitted by the second phosphor element has a longer wavelength than the light having the second spectral component.

3. The lighting device as claimed in claim 2, wherein the first conversion light is yellow light, the light having the first spectral component is red light, the light having the second spectral component is green light, and the second conversion light is red light.

4. The lighting device as claimed in claim 3, wherein the light having the first spectral component has a dominant wavelength of at least 580 nm and the second conversion light is deep-red light having a dominant wavelength of at least 605 nm.

5. The lighting device as claimed in claim 1, wherein the coupling-out mirror is transmissive in the first spectral range and reflective in the second spectral range.

6. The lighting device as claimed in claim 1, wherein a limiting wavelength between the first spectral range and the second spectral range is at least 570 nm and at most 610 nm.

7. The lighting device as claimed in claim 1, wherein at least part of the light having the first spectral component, downstream of the coupling-out mirror is available in an output beam path at the output of the lighting device, wherein a beam path having at least part of the second conversion light, at least in sections, is guided along the same output beam path and is available at the same output.

8. The lighting device as claimed in claim 1, wherein the first and the second phosphor elements are provided in each case in layer form, wherein these phosphor element layers are arranged in direct optical contact with one another.

9. The lighting device as claimed in claim 7, wherein a coupling-in mirror is arranged in the beam path having at least part of the first conversion light, on which coupling-in mirror the beam path having at least part of the second conversion light is incident, wherein the coupling-in mirror is transmissive for the first conversion light and reflects the second conversion light or is reflective for the first conversion light and transmits the second conversion light, such that the beam path having at least part of the second conversion light, downstream of the coupling-in mirror and the coupling-out mirror, is coupled to the output beam path.

10. The lighting device as claimed in claim 1, wherein the second phosphor element is operated in transmission, and wherein the beam path having at least part of the light having the second spectral component that is separated by the coupling-out mirror is guided onto an incidence side of the second phosphor element and the second conversion light is guided away from an emission side opposite thereto.

11. The lighting device as claimed in claim 10, wherein a decoupling mirror is arranged between the first and the second phosphor elements, the decoupling mirror being reflective in the first spectral range and transmissive in the second spectral range.

12. The lighting device as claimed in claim 11, wherein the decoupling mirror is provided in a direct optical contact with the first and/or the second phosphor element.

13. The lighting device as claimed in claim 11, wherein at least part of the light having the first spectral component, downstream of the coupling-out mirror is available in an output beam path at the output of the lighting device, wherein a beam path having at least part of the second conversion light, at least in sections, is guided along the same output beam path and is available at the same output, wherein a coupling-in mirror is arranged in the beam path having at least part of the first conversion light, on which coupling-in mirror the beam path having at least part of the second conversion light is incident, wherein the coupling-in mirror is transmissive for the first conversion light and reflects the second conversion light or is reflective for the first conversion light and transmits the second conversion light, such that the beam path having at least part of the second conversion light, downstream of the coupling-in mirror and the coupling-out mirror, is coupled to the output beam path, and wherein the beam path having at least part of the second conversion light is guided past the first and the second phosphor elements to the coupling-in mirror.

14. The lighting device as claimed in claim 1, wherein the second phosphor element is arranged upstream of the coupling-out mirror in the beam path having at least part of the first conversion light, wherein the coupling-out mirror guides a part not converted upon the first passage through the second phosphor element as the light having the second spectral component back to the second phosphor element.

15. The lighting device as claimed in claim 1, wherein the first phosphor element is provided on a rotary body, which is mounted rotatably about a rotation axis.

16. The lighting device as claimed in claim 15, wherein the second phosphor element is provided on a rotary body, which is mounted rotatably about a rotation axis.

17. The lighting device as claimed in claim 16, wherein the first and the second phosphor elements are arranged on the same rotary body which is mounted rotatably, wherein the first and the second phosphor elements are arranged on different sides of a main body of a phosphor wheel.

18. The lighting device as claimed in claim 15, wherein the coupling-out mirror is provided on a rotary body, which is mounted rotatably about a rotation axis.

19. The lighting device as claimed in claim 15, wherein the coupling-out mirror is transmissive or reflective for the pump radiation.

20. The use of a lighting device for illumination with a mixture of a light having a first spectral component and a second conversion light comprising,
emitting pump radiation by a pump radiation source,
converting the pump radiation into a first conversion light by a first phosphor element,
generating the second conversion light by a second phosphor element, and
arranging a coupling-out mirror, downstream of the first phosphor element in a beam path, with at least part of the first conversion light,
wherein the first conversion light is a broadband conversion light having components in a first spectral range and a second spectral range, which is different from the first spectral range, wherein the coupling-out mirror arranged in the beam path with at least part of the first conversion light is transmissive in one of the two spectral ranges but is reflective in the other spectral range, such that, downstream of the coupling-out mirror, light having the first spectral component in the first spectral range and light having a second spectral component in the second spectral range are present in a separated fashion, wherein at least part of the light having the first spectral component is available at an output of the lighting device, and wherein the second phosphor element is arranged in a beam path with at least part of the light, separated by the coupling-out mirror, having the second spectral component and, in response to this excitation, emits the second conversion light, which can be used jointly with the light having the first spectral component in order to increase the efficiency.
